(19) United States
(12) Patent Application Publication
(10) Pub. No.: US 2011/0042905 A1
(43) Pub. Date: Feb. 24, 2011

(54) Fire And Chemical Resistant Gasket

(76) Inventor: Richard Schroder, Lebanon, OH (US)

Correspondence Address: WM. CATES RAMBO;508 MERCANTILE LIBRARY BLDG., 414 WALNUT STREET, CINCINNATI, OH, 45202-3913, US

(21) Appl. No.: 12/853,761

(22) Filed: Aug. 10, 2010

Related U.S. Application Data
(60) Provisional application No. 61/234,682, filed on Aug. 18, 2009.

(51) Int. Cl. F16L 19/03

(52) U.S. Cl. 277/614; 277/608

(57) ABSTRACT

An annular, chemically nonreactive shell 18 is formed with a base 42, a radially inwardly disposed surface 28 and with a pair of sidewalls 30, 32 that are raised relative to the base. A fire resistant, intermediate core 20 is formed with an annular body 36 and with a radially outwardly projecting end 34. A substantial portion 24 of the core 20 is mounted between the sidewalls 30, 32 of the shell. When installed between opposing pipe flanges 12, the radially inwardly disposed surface 28 of the shell 18 is compressed between the pipe flanges 12 adjacent to the bores of the pipes 14 and provides a fluid tight seal to prevent a process stream 16 from reaching the core. Likewise, the sidewalls 30, 32 are compressed by the pipe flanges 12 and, in turn compress the core portion 24 disposed therebetween. The outer end 34 and a radially outwardly disposed portion 26 of the core 20 expand to protect the shell 18 from heat and flame.

### CROSS REFERENCE TO RELATED APPLICATION

The present U.S. Non-Provisional Patent Application is related to Provisional Application No. 61/234682 filed Aug. 18, 2009 and entitled “Fire Resistant Gaskets And Methods For Producing Them”, and is incorporated herein by reference in its entirety.

### BACKGROUND OF THE INVENTION

1. Field of the Invention

The present invention relates to the design and fabrication of gaskets, o-rings and seals adapted to provide a fluid tight seal between industrial process pipes and more particularly to those suitable for use where flammable substances may be included in the process stream.

2. Related Art

Fire safety has always been a concern for industrial plant workers and the communities that surround them. Fires can be costly in terms of lives and property if they occur in industries that contain few if any combustible chemicals. Where the process piping carries flammable materials, fire prevention is an even greater concern. Leaks or ruptures in these systems can compound the problem of fire containment, cause explosions, pollute the environment, and further endanger life and property.

The process piping used in paint lines and chemical industries is often fabricated from stainless steel and provides adequate protection in a fire for a reasonable amount of time. However, where the stainless pipe sections are joined, a gasket is normally used. These gaskets can be the “weak link” in a fire, as they are likely to burn through first. They need to be sufficiently compressible to form a seal between the pipes, chemically resistant to corrosive or highly reactive chemicals and fire resistant. In the past, it has been difficult to satisfy all these requirements in the same gasket. Thus, it is believed that there is a need is for a gasket that is resistant to both chemicals and fire and sufficiently compressible to form a leak-proof seal during normal use and for a reasonable amount of time when exposed directly to flame or to the intense heat generated by a fire.

### SUMMARY OF THE INVENTION

The present gasket is mountable between the flanges of two process pipes or other conduits for conducting a process stream. The gasket basically comprises an annular chemically inert shell and an annular fire-resistant core. The shell is formed with a radially inwardly disposed surface and with a pair of flange-engaging sidewalls. The chemically inert shell extends between the flanges of the process conduits to provide a fluid tight seal adjacent to the process stream. The core is formed with a radially outwardly disposed end and with an annular body. At least a portion of the annular body is compressible between the sidewalls of the shell, and the core forms an outwardly disposed fire-resistant barrier.

### BRIEF DESCRIPTION OF THE DRAWINGS

FIG. 1 is a fragmentary side view of the exemplary gasket mounted between adjoining process pipes through which a process stream flows;

FIG. 2 is a front view of the exemplary gasket.

FIG. 3 is a side view of the subject gasket.

FIG. 4 is an enlarged sectional view of the gasket taken along line 4-4 of FIG. 3.

FIG. 5 is an enlarged sectional view taken along line 5-5 of FIG. 1 and particularly illustrates the compression of the subject gasket between the process pipes; and

FIG. 6 is a front view of an intermediate core for the subject gasket.

### DETAILED DESCRIPTION OF AN EXEMPLARY EMBODIMENT

As illustrated in FIG. 1, the present gasket, generally designated 10, is adapted to be mounted between opposing flanges 12 on a pair of process pipes or conduits 14 through which a process stream 16 flows.

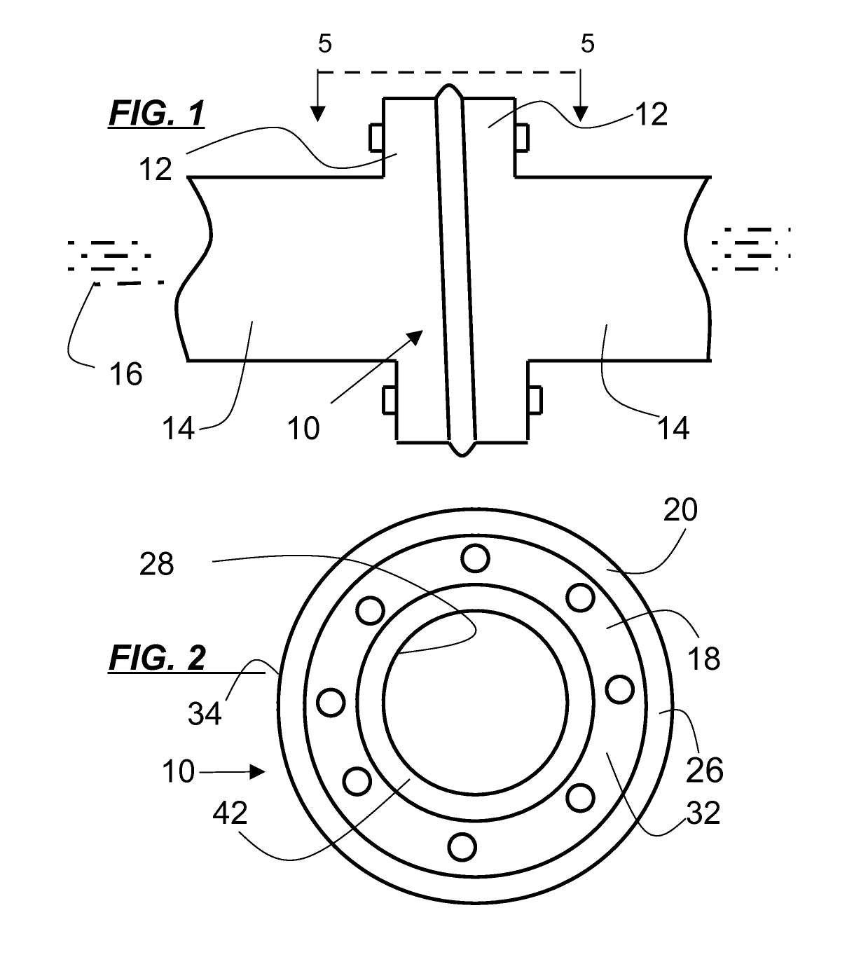

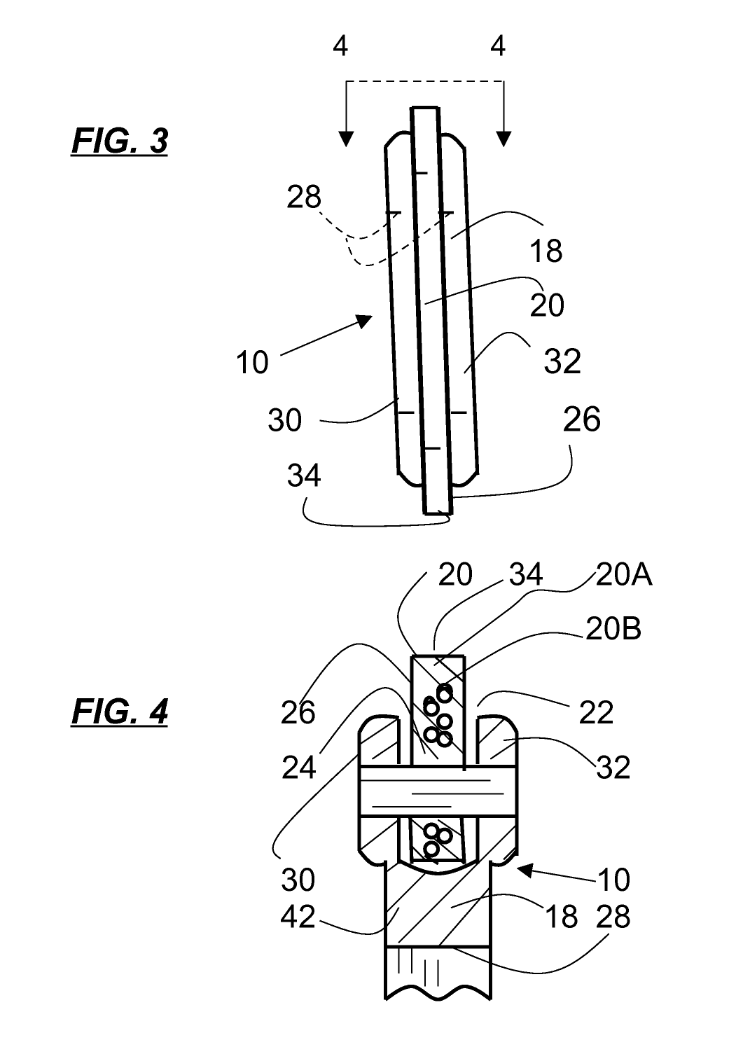

As illustrated in FIGS. 2-4, the gasket 10 basically comprises an annular shell 18 formed from chemically inert material and an annular intermediate core 20 formed from fire resistant and compressible material. For example, the shell 18 may be formed from partially or fully halogenated polymers or co-polymers, and the core 20 may be formed from an elastomeric matrix 20A and a non-combustible filler 20B (FIG. 4) such as glass beads or carbon fiber. In addition to being chemically resistant, the shell 18 may be formed from one or more substances that, upon reaching its boiling point, emits fire suppressing fumes.

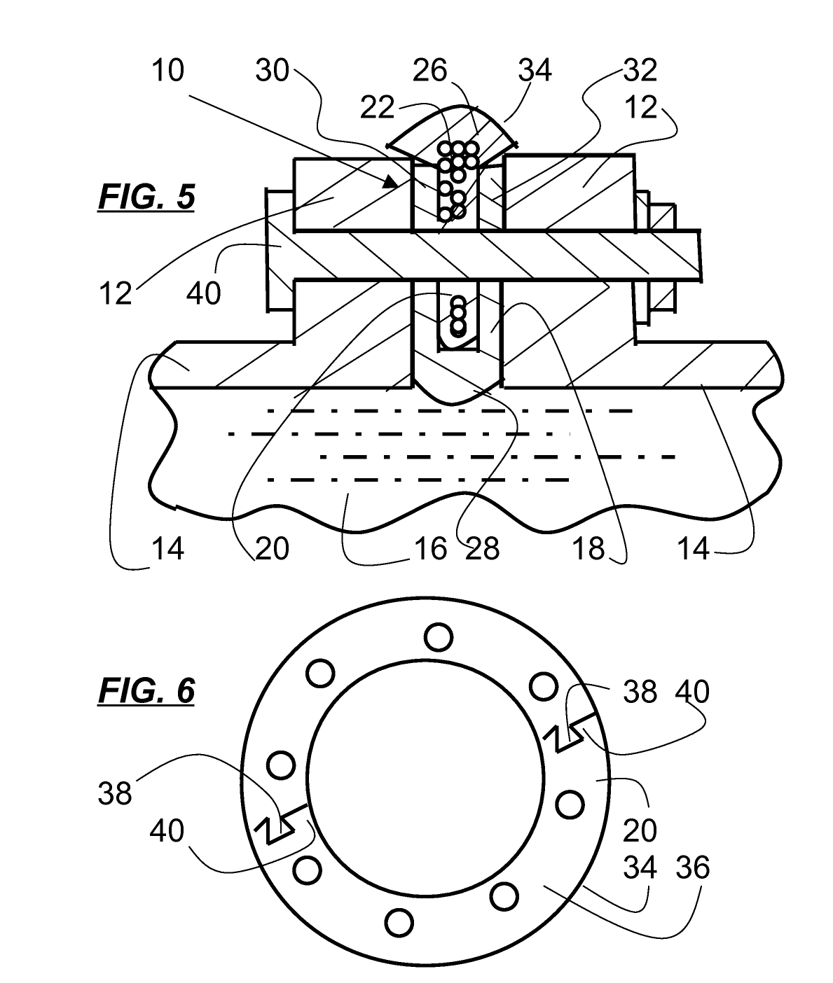

The shell 18 may be formed with a radially inwardly disposed, generally cylindrical surface 28 and with a pair of flange-engaging sidewalls 30, 32. The inwardly disposed, chemically inert surface 28 of the shell may be compressed between the conduit flanges 12 (FIG. 5) to form a fluid tight seal adjacent to the process stream 16 upon tightening the gasket 10 between the flanges 12, 14 thereby preventing the process stream 16 from reaching the relatively more chemically reactive core 20. An outwardly opening, annular slot or channel 22 (FIG. 4) may be formed between the sidewalls 30,32 of the shell 18 and may be disposed to receive at least a portion 24, such as 60-80%, of the intermediate core 20. Alternatively, the shell 18 may be over-molded around at least the portion 24 of the core 20. The sidewalls 30, 32 may be raised relative to a base portion 42 (FIGS. 2,4) of the shell 18. In this manner, additional compressive force may be applied to the core 20 upon tightening the bolts 40 or other fasteners (FIG. 5) extending through the flanges 12 and gasket 10. In addition, the sidewalls 30, 32, once compressed between the conduit flanges 12, may serve as a backup fluid-tight seal to prevent the potentially corrosive or oxidative process stream 16 from reaching the core 20.

The fire resistant core 20 may be formed with a radially outwardly disposed end 34 and with an annular body 36 (FIG. 6), at least a portion 24 of which is compressible between the shell sidewalls 30, 32 (FIG. 4). In addition to the portion 24 disposed between the shell sidewalls 30, 32, another portion 26 of the core 20 may project radially outwardly from the shell 18 (FIGS. 2-5). As illustrated in FIG. 6, the core may be formed with two diametrically opposing sets of interlockable members 38, 40 extending generally diametrically therethrough. One of the members 38 may be generally dovetail in shape or another insertable configuration, and the other member 40 may be formed into a cooperative receiving socket. In this manner, the fire resistant core 20 may be mounted in or removed from the slot or channel 22 in the shell 18 without being deformed, and the adjoining ends 38, 40 may substantially maintain the fire-resistant properties of the core 20. Alternatively, depending upon the flexibility of the core 20 and/or the shell 18, the core 20 may be unitary (FIG. 2) or a single set of interlockable members may be provided. In either of the alternative configurations, the core 20 may be deformed until seated in the shell channel 22.

As illustrated in FIG. 5, the sidewalls 30, 32 of the shell 18 and the received portion 24 of the core may be compressed upon tightening the gasket 10 between the process pipe flanges 12 by means of the bolts 40 or other fasteners extending through the flanges 12 and the gasket 10. Also upon compression, the outwardly projecting portion 26 of the intermediate core 20 may expand to substantially meet the conduit flanges 12, and the outwardly disposed end 34 may expand beyond the conduit flanges 12. In this manner, the outer end 34 and the outwardly projecting core portion 26 may protect the relatively less fire resistant shell 18 from heat and flames.

The foregoing description of an exemplary form of the present gasket is not intended to unduly limit or restrict the scope or construction of the following claims.

1. A gasket mountable between the opposing flanges of two process conduits disposed to conduct a process stream, said gasket comprising:
a. an annular chemically inert shell formed with a radially inwardly disposed surface and with a pair of flange-engaging sidewalls,
b. an annular fire-resistant core formed with a radially outwardly disposed end and with an annular body, at least a portion of said annular body being compressible between the side walls of the shell, said core providing a radially outwardly disposed, fire resistant barrier; and
c. said chemically inert shell extending between the opposing flanges of the process conduits to provide a fluid tight barrier between the process stream and the fire resistant core.

2. The gasket according to claim 1, wherein the shell is formed from at least partially halogenated polymers or co-polymers, and the core is formed from an elastomeric matrix and a non-combustible filler from a group comprising glass beads and carbon fibers.

3. The gasket according to claim 1, wherein an outwardly opening, annular channel is disposed between the sidewalls of the shell, and wherein at least a portion of the intermediate core is mountable in said channel.

4. The gasket according to claim 1, wherein the inwardly disposed, chemically inert surface of the shell is compressible between the flanges of the conduits to form the fluid tight barrier.

5. The gasket according to claim 1, wherein the shell is over-molded around at least the portion of the core.

6. The gasket according to claim 1, wherein the sidewalls are raised relative to a base portion of the shell.

7. The gasket according to claim 6, wherein the sidewalls of the shell are compressible between the flanges of the conduits to form the fluid tight barrier.

8. The gasket according to claim 1, wherein the core is formed with at least one set of interlockable members extending generally diametrically through said core.

9. The gasket according to claim 1, wherein a second portion of the core projects radially outwardly from the shell.

10. The gasket according to claim 9, wherein the second portion of the core expands upon compression of the first portion of the core body.

11. The gasket according to claim 10, wherein said second core portion expands to meet the flanges of the conduits upon compression of the first portion of the core body.

12. The gasket according to claim 1, wherein the radially outwardly disposed end of the core expands upon compression of the first portion of the core body.

13. The gasket according to claim 12, wherein said core end expands beyond the flanges of the conduits upon compression of the first portion of the core body.

14. The gasket according to claim 1, wherein the shell is formed from at least one substance that emits fire suppressing fumes upon reaching its boiling point.
